(19) United States
(12) Patent Application Publication
(10) Pub. No.: US 2014/0159884 A1
(43) Pub. Date: Jun. 12, 2014

(54) VEHICLE SAFETY SYSTEM FOR MANDATORY DRIVER INSPECTION TO ENSURE THAT PASSENGERS HAVE ALL DISEMBARKED

(71) Applicants: April Braun, Lantana, FL (US); Jerry P. Braun, Fairborn, OH (US)

(72) Inventors: April Braun, Lantana, FL (US); Jerry P. Braun, Fairborn, OH (US)

(21) Appl. No.: 13/939,586

(22) Filed: Jul. 11, 2013

Related U.S. Application Data
(60) Provisional application No. 61/670,396, filed on Jul. 11, 2012.

(51) Int. Cl. B60Q 5/00

(52) U.S. Cl. CPC B60Q 5/00
USPC 340/433

(57) ABSTRACT

An improved vehicle safety system for transport operators designed to require the driver of a passenger vehicle to fully check the entire vehicle before exiting, thereby ensuring that no passenger is left behind. The driver is required to turn a key in the switch located at the back of the vehicle to disable the alarm. This keyed switch absolutely ensures driver compliance, much more so than conventional timers with a disable button. The system is implemented with simple and reliable relays and other components.

### CROSS-REFERENCE TO RELATED APPLICATION(S)

The present application derives priority from U.S. Provisional Patent Application Ser. No. 61/670,396 filed 11 Jul. 2012.

### BACKGROUND OF THE INVENTION

1. Field of the Invention

The present invention relates generally to safety systems for commercial transportation operators and, more particularly, to a vehicle safety system for transport operators designed to require the driver of a passenger vehicle to fully check the entire vehicle before exiting, thereby ensuring that no passenger is left behind.

2. Description of the Background

The news is replete with accounts of incidents involving children inadvertently left on school buses by negligent drivers that fail to fully check the bus after dropping the other children off. As seen in FIG. 1, most bus operators have employee policies that require drivers to check their bus for students who might have fallen asleep, and many post signs at bus stops as a reminder. These precautions have proven ineffective at preventing the problem, and the consequences of driver inattention can be catastrophic. Children are often unable to disembark the bus on their own and can become trapped for hours. Many have suffered from heat exhaustion and dehydration, and some have died. By news accounts there were 85 such instances in 2011, and 58 so far in 2012, and many such instances are never reported.

Technology offers a more effective approach to the problem, and indeed at least four states including Tennessee, Arkansas, Wisconsin and Louisiana, have laws requiring buses and daycare vehicles to have vehicle reminder systems. Such systems generally prompt the driver to check the vehicle for children before they disembark.

For example, Child Safety Technologies, LLC, sells the Child Guardian Reminder System™. When the driver shuts off the vehicle, the system prompts the driver to check the vehicle for children. The driver must walk to the back of the vehicle and swipe a key card past a magnetic sensor. If the system is not reset within a predetermined amount of time an alarm goes off.

U.S. Pat. No. 5,874,891 to Lowe discloses a system for reminding drivers to check for remaining passengers or articles left behind on a bus and to perform an inspection of the rear door on a bus to ensure that it is working properly. When the driver completes a run and turns off the ignition switch, the system enters an alarm state and a buzzer sounds. The buzzer is silenced only when the driver walks to the back of the bus and opens and closes the rear door.

Similarly, U.S. Pat. No. 7,117,121 to Brinton et al. issued Oct. 3, 2006 discloses a system to ensure performance of mandated pre/post-trip inspections of vehicles. The system activates upon powering off the vehicle, waits a period of time for an inspection to be performed, and sounds an alarm if the inspection has not been performed. The system employs a hand-held transponder that prompts a driver to walk to the back of the bus, checking proximity to an RFID tag at the back of the bus to ensure compliance.

Though the foregoing and other prior art references are far more effective than employee policies and signs, they still leave some room for driver negligence and only mitigate the risk of a sleeping child being left on the bus. Moreover, they rely on sophisticated computer electronics for determining when to sound an alarm. What is needed is a simple control system that can be wired into the existing vehicle electrical system and that imposes an analog logic scheme using relays rather than software. It would also be desirable to avoid total reliance on audible alarms.

### SUMMARY OF THE INVENTION

It is, therefore, a primary object of the present invention to provide a vehicle safety system for transport operators designed to require the driver of a passenger vehicle to fully check the entire vehicle before exiting, thereby ensuring that no passenger is left behind.

It is another object to provide a failsafe vehicle safety alarm system suited for transporting young children, that relies on a combination of a door switch system, a key lock switch, and a timer mechanism, which in combination requires any vehicle driver to properly inspect his or her vehicle before leaving that vehicle for an extended period of time.

It is another object to provide a vehicle safety system for transport operators that is based on inexpensive and generic components suitable for installation to a wide range of vehicles.

It is still another object to provide a vehicle safety system designed to use conventional off-the-shelf (COTS) components that meet all American industrial standards and specifications.

In accordance with the foregoing objects, the present invention is a vehicle safety system for transport operators designed to require the driver of a passenger vehicle to fully check the entire vehicle before exiting, thereby ensuring that no passenger is left behind. After returning from a route and turning off the ignition, the vehicle safety system arms and begins a timer countdown. Within the allotted time the driver is required to insert and turn a cylindrical key in a keyed switch located at the back of the vehicle in order to disable the alarm. Failure to timely comply activates the alarm. The vehicle safety system is wired directly to the doors of the vehicle to compel compliance, rather than just being a timer with a disable button.

The foregoing design in combination with other design details to be described eliminates the risk of a sleeping child being left on the bus through driver negligence, and does so in a simple, cost-effective way that can be wired into the existing vehicle electrical system in order to physically prevent the driver from disembarking until the mandatory inspection is completed.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a perspective view of a bus operator fulfilling a typical policy requiring drivers to check their bus for students who have fallen asleep

FIG. 2 is a schematic diagram of a vehicle safety system 2 according an embodiment of the present invention.

FIG. 3 is a schematic diagram of a vehicle safety system 102 according to another embodiment the, shown in Alarm Mode.

FIG. 4 is a schematic diagram of the vehicle safety system 2 as in FIG. 3 shown in Alarm Reset Mode.

FIG. 5 is a schematic diagram of a fused connection for supplying +12 (VDC) power to the relays R1-R5 of FIGS. 3-4.

FIG. 6 is a schematic diagram of a fused connection (similar to that of FIG. 5) for supplying +12 (VDC) power to the relays R1-R5 through a voltage divider B-1, when voltage regulation is needed.

FIG. 7 is a schematic diagram of another embodiment of the EAC safety system 202. This embodiment of EAC safety system 202 is implemented with digital circuitry rather than relays.

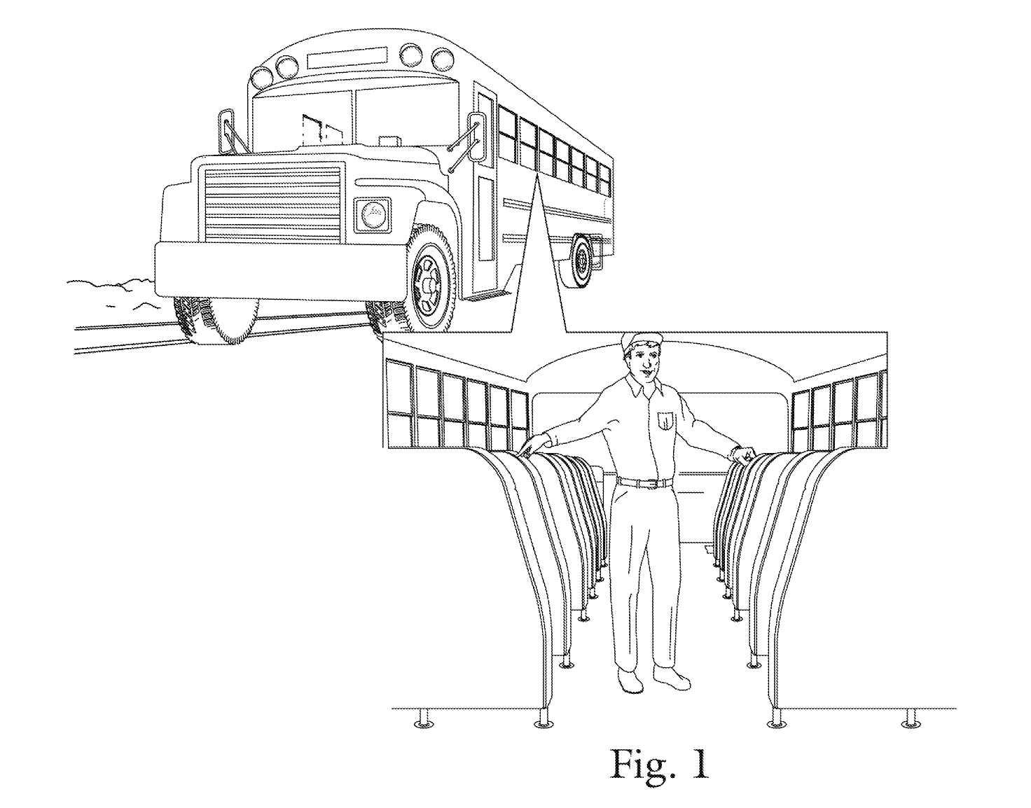

### DETAILED DESCRIPTION OF THE PREFERRED EMBODIMENT

Reference will now be made in detail to preferred embodiments of the present invention, examples of which are illustrated in the accompanying drawings. Wherever possible, the same reference numbers will be used throughout the drawings to refer to the same or like parts.

The present invention is an alarm safety system for transport operators designed to require the driver of a passenger vehicle to fully check the entire vehicle before exiting, thereby ensuring that no passenger is left behind. The alarm safety system includes an Electronic Alarm Controller (EAC) at the front of the vehicle and connected to existing vehicles wiring, and a cylindrical key switch at the rear of the bus also connected to the EAC. After returning from a route and turning off the ignition, the EAC arms itself and begins a timer countdown. Within an allotted time the driver is required to insert and turn a cylindrical key in a keyed switch at the back of the vehicle in order to disable the alarm. Failure to timely comply activates the alarm.

The cylindrical key comprises a body provided with an axial bore that fits into a lock cylinder of cylindrical form that is rotatable in one angular direction. The key may be removed at one angular position of the cylinder. The key can be carried along with the vehicle ignition key on a common key ring. It is not to be left in the key switch, but is only to be used at the time the EAC is to be reset and turned off. The use of a cylindrical key and key switch is advantageous because it allows the driver to insert the key in any angular position, the coupling between the key and the key switch cylinder taking place in an angular position determined by the co-operation of a male profile of the key with a corresponding female profile of the key switch cylinder. A unique set of cylindrical keys is associated with each system described below eliminating the possibility of someone outside of the operator being able to reset the system. This ensures that each vehicle operator has control of the system. The cylindrical key switch also prevents tampering of the alarm reset function by children. In comparison with security key cards, which require electronic equipment to be installed on the vehicle, use of the present cylindrical key switch assembly in accordance with the operational logic described below facilitates a retrofit installation to typical buses that entails running only two wires from the key switch at the rear of the vehicle forward to the alarm system box at the front.

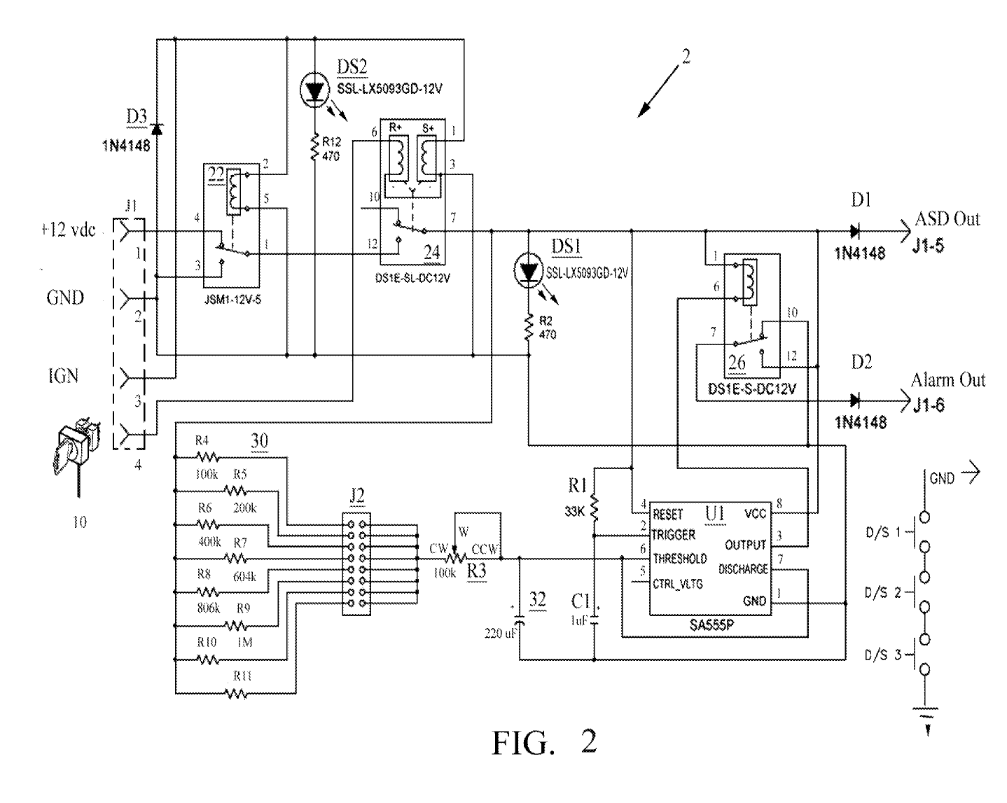

FIG. 2 is a schematic diagram of a vehicle safety system according to an embodiment of the present invention.

As shown at left, the safety system includes EAC 2 housed in a single enclosure mounted at the front of the vehicle, connected to the cylindrical key switch 10 at the rear of the vehicle, and also connected to existing vehicle wiring harness(es) which include: (a) 12 (VDC) battery buss; (b) vehicle (battery) ground (GND) (buss); c) a vehicle ignition (on bus), and d) the existing vehicle magnetic door switches. Typically, there are dual magnetic door-switches (DSL and DSR) which indicate front left and right door open/closed status, these being connected in series for tandem operation. Additional wiring must be installed to connect an alarm module (AL) described below (an audio and/or visual and/or voice alarm) to the EAC 2. The existing vehicle wiring harness inclusive of the referenced lead wires can generally be accessed at a connector at the vehicle dash.

Relays 22, 26 comprise single-pole double-throw (SPDT) non-latching relays. Relay 24 is a single-pole double-throw (SPDT) latching relay.

Timer U1 in combination with resistor bank 30, jumper connector J2, variable resistor R3 and capacitor 32, collectively form a settable timing circuit. Timer U1 may be a Texas instruments SA555P timer and resistor bank 30, variable resistor R3 and capacitor 32 create the desired time delay required. Internal jumpers in resistor bank 30 allow the time to be set to preselected times from thirty seconds up to several minutes. The use of jumper board J2 and resistor bank 30 allows manual selection of an incremental timeframe, which helps to eliminate the possibility of someone altering the specified timeframe electronically and also adds some flexibility should the need to increase or decrease the alarm timeframe become necessary. Variable resistor R3 provides a continuous fine adjust.

In operation, the EAC 2 becomes “armed” when the ignition is turned on, and thereafter has two primary modes: Alarm Set Mode, and Alarm Reset Mode.

The EAC 2 enters Alarm Set Mode upon parking the vehicle. At this point the ignition IGN is turned off and the vehicle is parked. Once the ignition IGN has been turned off, the system 2 initially outputs signal via ASD Out (which may indicate via signal light, audio alarm, or voice enunciator) to signal the driver that the EAC 2 is armed. The Alarm Mode remains in effect until the vehicle alarm is reset by insertion of the key into key switch 10 at the rear of the bus. Failure to do so by the time timer U1 counts down sounds an alarm on Alarm Out, assuming that all doors switches D/S 1, D/S 2, D/S 3, etc. are closed. If any of the doors is open, this will temporarily interrupt the Alarm Out and the alarm will turn off. However, once all doors are again closed the Alarm Out will turn back on.

To implement this, +12 vdc from the vehicle power system is always applied to J1 pin 1. This voltage is fed to relay 22 at pin 4 and is output to pin 1 when relay 22 is in its normally closed position as shown. Relay 24 is initially in the “reset” state and so pin 12 is not initially connected to pin 7 through the relay. However, pin 1 of relay 22 is connected to pin 12 of relay 24. Relay 24 is a latching relay. While the ignition is off the +12 vdc voltage at relay 22 pin 2 is removed causing relay 22 to reset which causes pin 4 to connect with pin 1 applying +12 vdc to pin 12 of set relay R24. At this point the EAC 2 is in a “state of rest” waiting for the ignition to be turned on. To arm, with the circuit connected as described above, the ignition is activated, +12 vdc voltage from ignition flows to pin 3 of the EAC 2 connector J1. Diode D3 ensures that relay 22 stays “latched” once the relay 22 is set. With +12 vdc ignition voltage at relay 22 pin 2, and ground at relay 22 pin 5, relay 22 “sets” causing pin 3 to connect to pin 1. Ground is now sent to pin 12 of relay 24. In addition, LED (light emitting diode) DS2 comes on. This LED is not visible to the driver but ensures that relay 22 has latched and is used for troubleshooting. The +12 vdc ignition voltage is also applied to the set side coil of relay 24 at pin 1 and ground is applied to realy 24 pin 3, which causes relay 24 to set allowing the ground at pin 12 to pass through to relay 24 pin 7. The EAC 2 is now in the “armed state” with relay 24 set, and the system is simply waiting for the ignition to be turned off.

+12 vdc voltage is also sent from the vehicle electrical system to illuminate LED DS1. This LED DS1 is visible outside of the EAC 2 and notifies the operator that the EAC 2 is now “armed”.

After running a route the vehicle is parked the ignition key is turned off, and the EAC 2 advances to Alarm Set Mode. +12 vdc ignition is removed from J1-3, relay 22 resets, +12 vdc is now sent to pin 12 of relay 24. Furthermore, the +12 vdc voltage is sent to the delay timer U1 and to the resistor selection bank 29 and an Alarm Reset countdown begins. The countdown is manually programmable. Jumper board J2 may be set to any incremental resistor R4-R11 and any incremental delay time, e.g., selecting resistor R6 selects a delay time of 60 seconds. Capacitor C2 is coupled with the selected resistor of selection bank 29 to determine the time delay threshold for the output of the delay timer U1 to become active while C1, R1 and R3 determine the trigger. At this point the only output which is “active” (plus voltage) is pin 5. The EAC module 2 pin 6 is currently at ground through the closed contacts of relay 26. If the time threshold for U1 is reached without the driver manually resetting the EAC system, the output pin 3 of U1 goes to ground, causing relay 26 to “activate” (putting +12 vdc voltage out) on pin 6 (Alarm Out) of the EAC module.

The EAC 2 preferably also employs the vehicle's existing door switches as part of the functionality. Specifically, the ground for Alarm Out is routed through each of the door switches D/S 1, D/S 2, D/S 3, etc., in series. This effectively prevents the system from signaling an alarm on Alarm Out if one or more of the doors is open. Assuming that all doors switches D/S 1, D/S 2, D/S 3, etc. are closed, the EAC 2 is capable of fully arming. At this time the ASD Out at pin 5 of the EAC 2 goes off notifying the operator (by light, sound or digital voice) to reset the alarm system within the predetermined countdown.

The EAC 2 remains in the fully armed state until the Alarm Reset Key 10 is activated. To disable the Alarm Out and ASD Out before or after it sounds the Alarm Reset Key 10 is engaged by the operator, causing +12 vdc voltage to be applied to Alarm Reset Key 10 at J1 pin 4 of the EAC module 2, which in turn causes relay 24 to latch to the “reset” state, thereby removing the +12 vdc plus voltage from output pin 5 of the EAC 2 and also generating a reset to pin 4 of the delay timer U1. The removal of the +12 vdc voltage from the coil of relay 26 causes it to reset and the output to pin 6 of the EAC is returned to ground causing the Alarm Out at J1 pin 6 to shut off. The EAC is now in the “fully reset state” and is once more awaiting for the ignition switch to be engaged. Until that occurs the EAC module 2 will remain in this state.

The EAC 2 is also disabled if any of the doors is opened to a sufficient amount (more than 1 inch typical). However, simply opening a door does not reset the EAC 2 and the alarm will still sound when said door(s) is (are) closed properly. The only means to reset the alarm after the EAC 2 has reached the fully armed state is via the Alarm Reset Key 10.

Prior to the EAC 2 reaching the “fully armed” state the EAC will return to the armed state by simply turning the vehicle ignition switch off. This allows the operator to perform multiple vehicle restarts without having to engage the Alarm Reset Key 10 after each restart. This is possible because although relay 24 is now in the “set” state the output of relay 24 is controlled by the input to relay 22 which will be ground whenever the ignition is in the OFF state. However, whatever is connected to the Audio Sound Device/Auxiliary output pin 5 will become active whenever the ignition is in the OFF state just as described above. This is due to the EAC module 2 “detecting” the vehicle to be in OFF state. If the operator does not perform a restart of the ignition or a reset via Alarm Reset Key 10 within the preselected timeframe the Alarm will trigger as designed.

Certain operational features are designed to facilitate a normal school route wherein the vehicle must be stopped numerous times without inventorying the back of the vehicle and fully resetting the alarm. So long as the engine is running, the vehicle alarm 2 remains disabled. If the driver must stop for a short period of time, leaving one of the doors open that has a magnetic door switch installed, this will prevent the alarm from sounding. If the driver decides to leave the key in the ignition in the run position with the engine off, the driver can simply start the engine from the ignition key run position and continue his trip without having to reset the vehicle alarm 2. Alternatively, as noted above, the driver may wish to temporarily reset the vehicle alarm system using the vehicle ignition key. For a temporary reset, while stopped, the driver must leave the ignition key in the run position, without turning on the engine. With the ignition key in the on position, this will initiate the Alarm Reset Mode.

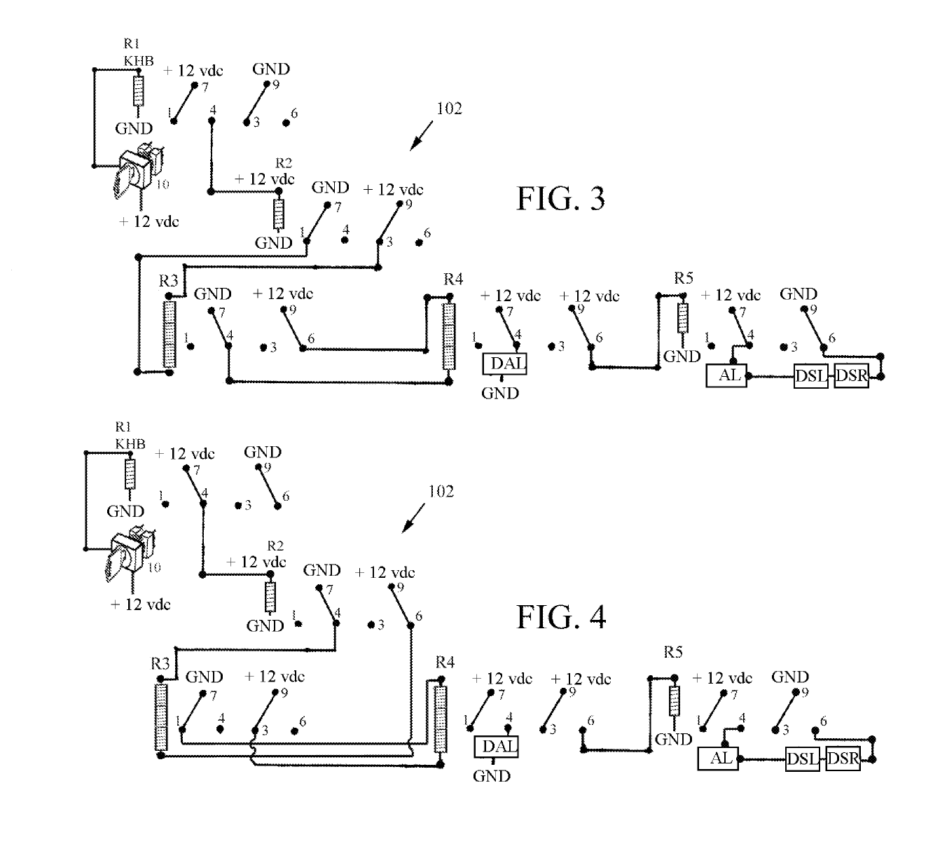

FIGS. 3-4 are schematic diagrams of a vehicle safety system 102 according to another embodiment, FIG. 3 showing system 102 in Alarm Mode and FIG. 4 in Reset Mode.

This embodiment of EAC safety system 102 is implemented with two standard double-pole double throw (DPDT) relays R1 & R2, two double-pole (double-throw (DP/DT) latching relays R3 & R4, and a double pole/double throw (DP/DT) timer relay R5, an alarm reset key ARK, an alarm module AL, and a driver alarm light DAL. The activation coil of the DPDT relay R1 is connected to the vehicle ignition lead and to ground. The activation coil of the DPDT relay R2 is connected to the vehicle ignition lead for selectively connecting lead R1₇ to R1₁ or R1₄, and in tandem connecting lead R1₉ to R1₃ or R1₆. The activation coil of the DPDT relay R2 is connected between R1₄ and ground for selectively connecting lead R2₇ to R2₁ or R2₄, and in tandem connecting lead R2₉ to R2₃ or R2₆. The activation coil of the DPDT latching relay R3 is connected between R2₁ and R2₃ for selectively connecting lead R3₇ to R3₁ or R3₄, and in tandem connecting lead R3₉ to R3₃ or R3₆. The activation coil of the DPDT latching relay R4 is connected between R3₄ and R3₆ for selectively connecting lead R4₇ to R4₁ or R4₄, and in tandem connecting lead R4₉ to R4₃ or R4₆. The activation coil of the DPDT timer relay R5 is connected between R4₆ and GND for selectively connecting lead R5₇ to R5₁ or R5₄, and in tandem connecting lead R5₉ to R5₃ or R5₆, in both cases after a predetermined interval. Alarm reset key Alarm Reset Key 10 is a keyed single-pole single-throw SPST cylindrical key switch that is connected to +12 VDC (KHB), and operable to connect the activation coil of the DPDT relay R1 in series with ground, thereby activating R1.

Alarm module AL is a visual and/or audio alarm module connected in series between R5₄ and the series-connected door-open leads DSL and DSR for sounding or indicating an alarm. Driver alarm light DAL is as stated and is connected between R4₄ and ground.

As above, the vehicle safety system has two primary modes: Alarm Set Mode, and Alarm Reset Mode. The system 102 enters Alarm Set Mode upon parking the vehicle. At this point the ignition key KHB is turned off and the vehicle is parked. Once the ignition key KHB has been turned off, the system 102 will advance to the Alarm Set Mode, and +12 (VDC) is removed from energizing coil of relay R1. This de-energizes R1 and opens contacts R1₇ to R1₄ (as shown in FIG. 3) providing no voltage to the energizing coil of R2. R2 becomes de-energized, connecting R2₇ and R2₁ and providing a ground path to the bottom of the R3 energizing coil. R2₉ is connected to R2₃ and this provides +12 (VDC) to the top of the R3 energizing coil. Latching relay R3 now becomes energized and moves to an un-latch position, remaining in the un-latch position for the remainder of the alarm set process. In this position R3₇ is connected to R3₄ (as shown) to provide a GND path to the bottom of the latching relay R4 energizing coil. R3₉ is connected to R3₆ to provide +12 (VDC) to the top of the R4 energizing coil. Consequently, latching relay R4 now becomes energized and moves into an un-latch position. R4 remains in the un-latch position for the remainder of the Alarm Set Mode. In this position R4₇ is connected to R4₄ as shown to provide a +12 VDC signal to the driver alarm light DAL, which illuminates. R4₉ is connected to R4₆ provide a +12 VDC to the energizing coil of R5. Timer relay R5 now becomes energized. Timer relay R5 begins to count down a preset time period, for example, 3 minutes. If the alarm system 102 is not reset by the driver in time, the timer relay R5 will throw and turn on the alarm module AL. When timer relay R5 throws, R5₇ is connected to R5₄ to provide +12 (VDC) to the (+) terminal of the alarm module AL. Alarm module AL is connected in series with the series-connected door magnetic switch leads DSL and DSR. Simultaneously, R5₉ is connected to R5₆, thereby providing a GND path to the series-connected door (switch) leads DSL and DSR and AL. Current flows through alarm module AL and provides an audio alarm. The Alarm Mode remains in effect until the vehicle alarm is reset (as will be described). Note that if either of the doors is forced open, this will temporarily interrupt the AL circuit and the alarm will go off. However, once all doors are again closed the AL alarm will turn back on.

The alarm system 102 may be temporarily reset by the driver turning the vehicle ignition key to the “on” position without starting the engine, or may be permanently reset by taking the alarm reset key ARK to the back of the bus, inserting it into the keyed single-pole single-throw SPST switch and turning. This applies power to the activation coil of R1 and resets the alarm as described in the reset operation below.

The vehicle alarm system 102 reset configuration is shown in FIG. 4. For a permanent reset the ignition key must be turned off. The driver must push the key switch 10 into the keyed slot at the back of the bus and turn the ARK key clockwise for a short period. The key switch 10 is a momentary (spring return) cylindrical key switch, as described above, that connects +12 VDC power to the top of R1 energizing coil. The bottom of the R1 coil is already connected to GND. While the key switch 10 is held in the reset position this energizes the R1 coil for a short period of time, connecting R1₇ and R1₄ to provide +12 (VDC) to the top of the R2 energizing coil, the bottom of the R2 coil already being connected to GND. R2 likewise energizes for a short period of time, and R2₇ is connected to R2₄ to provide a GND path to the top of the R3 energizing coil for a short period of time. R2₉ is connected to R2₆ to provide +12 VDC to the bottom of the R3 energizing coil for a short period of time. R3 becomes energized and moves into its latch position from the un-latch position. R3 will now remain in the latch position for the remainder of the Alarm Reset Mode. The key can now be removed from key switch 10. R3₇ is connected to R3₁ to provide a GND path for the top of the R4 energizing coil. R3₉ is connected to R3₃ to provide +12 VDC to the bottom of the R4 energizing coil. This energizes R4 and moves it into the latch position from the un-latch position. As with R3, R4 will now remain in the latch position for the remainder of the Alarm Reset Mode. R4₇ is disconnected from R4₄ removing +12 VDC power from the driver alarm light DAL, which extinguishes. R4₉ is disconnected from R4₆ removing the +12 VDC power from the top of the R5 energizing coil. R5 becomes de-energized. R5₇ is disconnected from R5₄ removing the +12 VDC power from the AL alarm module. R5₉ is disconnected from R5₆ removing the GND path from the door switch leads DSL and DSR. The vehicle alarm system 102 is effectively reset and turned off at this point.

As above, certain operational features are designed to facilitate a normal school route wherein the vehicle must be stopped numerous times without inventorying the back of the vehicle and fully resetting the alarm. So long as the engine is running, the vehicle alarm 2 remains disabled. If the driver must stop for a short period of time, leaving one of the doors open that has a magnetic door switch installed, this will prevent the alarm from sounding. If the driver decides to leave the key in the ignition in the run position with the engine off, the driver can simply start the engine from the ignition key run position and continue his trip without having to reset the vehicle alarm 2. Alternatively, as noted above, the driver may wish to temporarily reset the vehicle alarm system using the vehicle ignition key. For a temporary reset, while stopped, the driver must leave the ignition key in the run position, without turning on the engine. With the ignition key in the on position, this will initiate the Alarm Reset Mode. The +12 (VDC) signal is applied to the top of the energizing coil of R1 and remains there until the ignition key is turned off again. The bottom of the R1 energizing coil is already connected to GND, and so R1 becomes energized. R1₇ is connected to R1₄ to provide a +12 (VDC) signal to the top of R2. The bottom of the R2 energizing coil is already connected to GND, and so R2 becomes energized. R2₇ is connected to R2₄ providing a GND signal to the top of the R3 energizing coil. R2₉ is connected to R2₆ to provide +12 (VDC) power to the bottom of the R3 energizing coil. This energizes R3 which moves into the latch position from the un-latch position. R3 remains in the latch position for the remainder of the Alarm Reset Mode. R3₇ is connected to R3₁ to apply GND to the top of the R4 energizing coil. R3₉ is connected to R3₃ to provide a +12 (VDC) signal to the bottom of the R4 energizing coil. This energizes R4, which moves into the latch position from the un-latch position. As with R3, R4 will now remain in the latch position for the remainder of the Alarm Reset Mode. R4₇ is disconnected from R4₄ removing +12 (VDC) power from the driver alarm light DAL, which extinguishes. R4₉ is disconnected from R4₆ removing the +12 (VDC) power from the top of the R5 energizing coil. R5 becomes de-energized. R5₇ is disconnected from R5₄ removing the +12 (VDC) power from the AL alarm module. R5₉ is disconnected from R5₆ removing the GND path from the door switch leads DSL and DSR The vehicle alarm system 102 is temporarily reset at this point. So long as the ignition key is used to start the engine, the vehicle alarm system 102 will remain turned off. However, if the ignition key is turned off and/or removed from the vehicle, the alarm system will reinitiate the process of turning the alarm back on via Alarm Set and Alarm Mode described above.

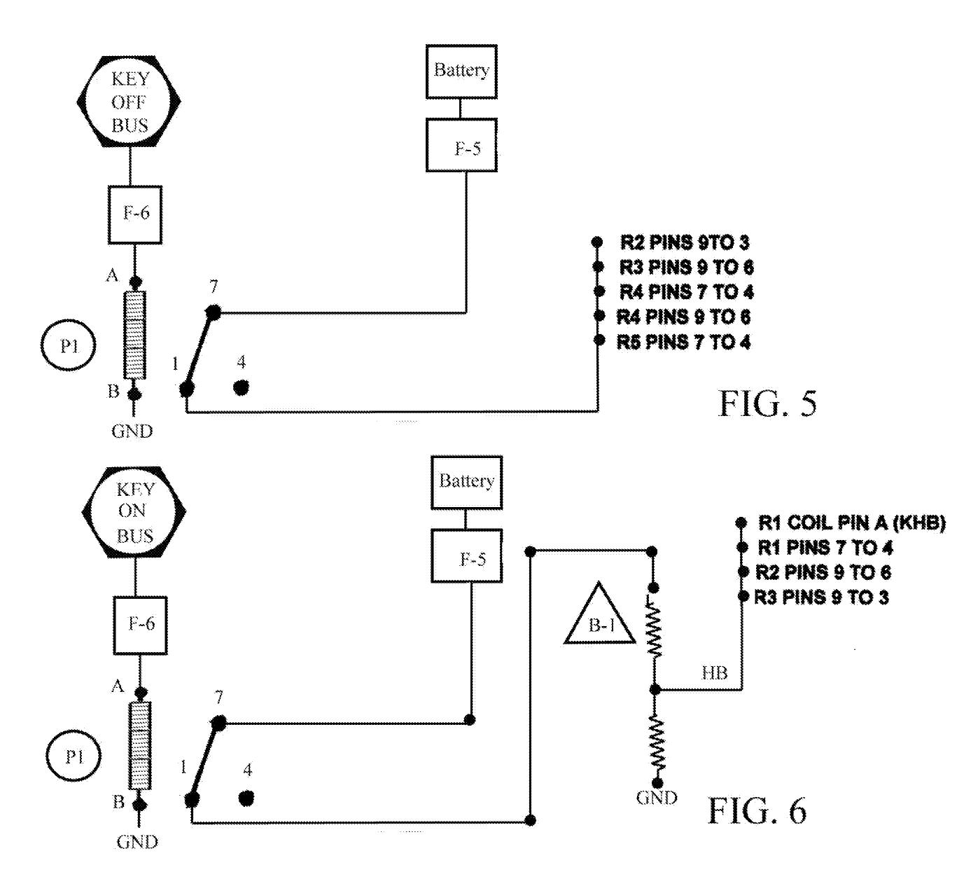

FIG. 5 is a schematic diagram of a fused connection for supplying +12 (VDC) power to the relays R1-R5 as shown in FIGS. 3-4. The +12 (VDC) is taken from the on-board vehicle battery and run through a fuse F-5, through the existing vehicle ignition relay P1 and to relays R1-R5.

In some cases a level of voltage regulation may be required for proper voltage bias or to avoid relay chatter. FIG. 6 is a simple schematic diagram of a fused connection (similar to that of FIG. 5) for supplying +12 (VDC) power to the relays R1-R5 through a voltage divider B-1 comprising a pair of resistors arranged in series. The regulated voltage is picked from between the series resisters B-1 as shown and used for powering relays R1-R5. The value of the pair of resistors is a matter of design choice depending on the other component requirements.

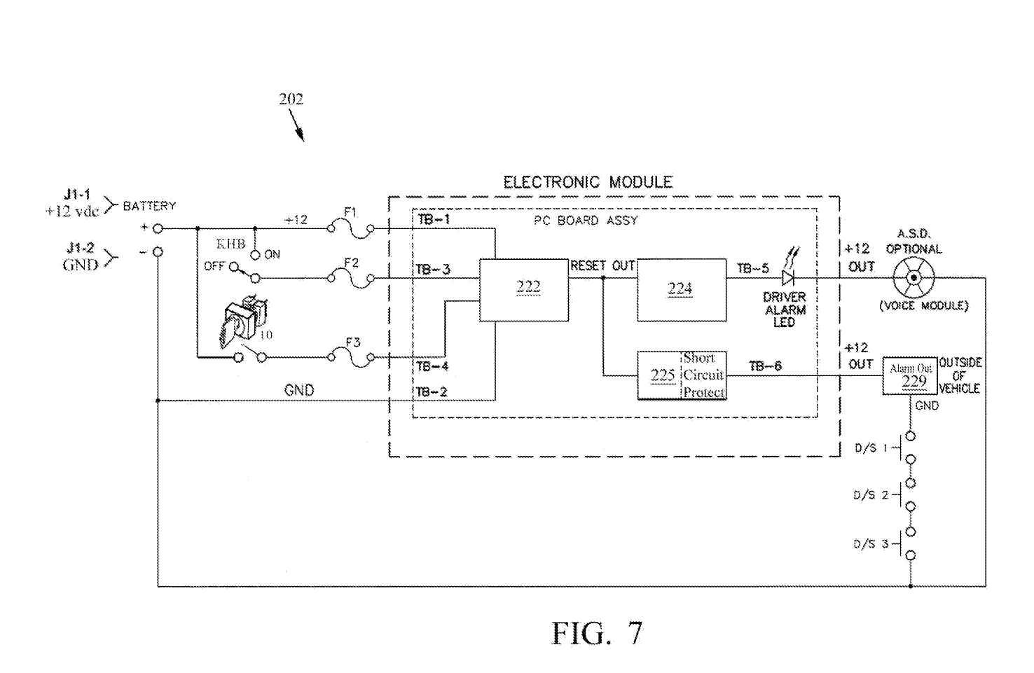

FIG. 7 is a schematic diagram of another embodiment of the EAC safety system 202. This embodiment of EAC safety system 202 is implemented with digital circuitry rather than relays. As above, the vehicle safety system has two primary modes: Alarm Set Mode, and Alarm Reset Mode. The system 202 enters Alarm Set Mode upon parking the vehicle. At this point the ignition key KHB is turned off and the vehicle is parked. Once the ignition key KHB has been turned off, the system 202 will advance to the Alarm Set Mode, and +12 (VDC) is removed from pin TB-3 of electronic reset module 222. Electronic reset module 222 is a combinatorial logic circuit that outputs reset logic “1” given a +12 vdc on J1-1 to TB-1 and no signal (ignition KHB off) on TB-3. A reset logic “1” output from module 222 arms electronic preset module 224 and also triggers a digital timer 225 (with optional short circuit protection) as shown). Preset module 224 initially signals a driver alarm LED and optional ASD alarm such as a voice enunciator, to signal the driver that the EAC 202 is armed. The Alarm Mode remains in effect until the vehicle alarm is reset by insertion of the ARK switch at the rear of the bus. Failure to do so by the time digital timer 225 counts down a programmable countdown sounds an alarm on ALARM OUT 229, assuming that all doors switches D/S 1, D/S 2, D/S 3, etc. are closed. Again, if any of the doors is forced open, this will temporarily interrupt the ALARM OUT 229 circuit and the alarm will turn off. However, once all doors are again closed the AL alarm will turn back on.

The EAC EAC 202 may be temporarily reset by the driver turning the vehicle ignition key to the “on” position without starting the engine, or may be permanently reset by taking the alarm reset key ARK to the back of the bus, inserting it into the keyed single-pole single-throw SPST switch and turning. This applies power to TB-4 of module 222 and resets the alarm as described in the reset operation below. The Alarm Mode remains in effect until the vehicle alarm is reset (as will be described). The EAC 202 may be temporarily reset by the driver turning the vehicle ignition key to the “on” position without starting the engine, or may be permanently reset by taking the alarm reset key ARK to the back of the bus, inserting it into the keyed single-pole single-throw SPST switch and turning. So long as the engine is running, the vehicle alarm 202 remains disabled. If the driver leaves a magnetic door switch open this will prevent the alarm from sounding. The driver may wish to temporarily reset the vehicle alarm system using the vehicle ignition key by leaving the ignition key in the run position, without turning on the engine. The vehicle EAC 202 is temporarily reset at this point. So long as the ignition key is used to start the engine, the vehicle EAC 202 will remain turned off. However, if the ignition key is turned off and/or removed from the vehicle, the alarm system will reinitiate the process of turning the alarm back on via Alarm Set and Alarm Mode described above.

It should now be apparent that the above-described EAC alarm system of embodiments 2, 102, 202 eliminate the risk of a sleeping child being left on the bus through driver negligence, and does so in a simple, cost-effective way using a retrofittable relay network that can be wired into most any existing vehicle electrical system.

Those skilled in the art will understand that various modifications and variations can be made in the present invention without departing from the spirit or scope of the invention. It is to be understood, therefore, that the invention may be practiced otherwise than as specifically set forth in the appended claims.

What is claimed is:

1. An improved vehicle safety system for transport operators to ensure that the driver of a passenger vehicle fully checks for remaining passengers in the vehicle before exiting the vehicle themselves, said vehicle having vehicle power, ground, ignition, and at least one door switch, the vehicle safety system comprising:
an electrical circuit comprising a countdown timer, and a switch connected between said vehicle ignition and said countdown timer, said switch activating said countdown timer upon turning off the ignition of said passenger vehicle;
an alarm module connected in series with the door switches of said passenger vehicle and configured to sound an alarm if said at least one door switch is closed and said electrical circuit countdown timer times out;
a key switch mounted at the back of the passenger vehicle for selectively preventing said alarm module from sounding despite said electrical circuit countdown timer timing out.

2. The improved vehicle safety system according to claim 1, wherein said key switch comprises a cylindrical key switch mounted at the back of the passenger vehicle.

3. The improved vehicle safety system according to claim 1, wherein said electrical circuit switch comprises a latching relay.

4. The improved vehicle safety system according to claim 3, wherein said latching relay comprises a single-pole double throw relay.

5. The improved vehicle safety system according to claim 13 wherein said electrical circuit switch comprises a first switch, second switch and third switch.

6. The improved vehicle safety system according to claim 5 wherein said first switch comprises a latching relay.

7. The improved vehicle safety system according to claim 6, wherein said latching relay comprises a single-pole double throw relay.

8. The improved vehicle safety system according to claim 5 wherein said second switch and said third switch both comprises a non-latching relay.

9. The improved vehicle safety system according to claim 8, wherein said second switch and said third switch both comprise a non-latching single-pole double throw relay.

10. The improved vehicle safety system according to claim 1, wherein said countdown timer comprises a manually settable countdown timer.

11. The improved vehicle safety system according to claim 10, wherein said manually settable countdown timer comprises a resistor bank with jumper connector.

12. An improved vehicle safety system to ensure that the driver of a passenger vehicle fully checks for remaining passengers in the vehicle before exiting themself, the vehicle safety system comprising:
an electrical circuit comprising a countdown timer, and a switch activating said countdown timer upon turning off the ignition of said passenger vehicle;
an alarm module connected in series with the door switches of said passenger vehicle and configured to sound an alarm if said electrical circuit countdown timer times out;
a key switch mounted at the back of the passenger vehicle for selectively preventing said alarm module from sounding despite said electrical circuit countdown timer timing out.

13. The improved vehicle safety system according to claim 12, wherein said key switch comprises a cylindrical key switch mounted at the back of the passenger vehicle.

14. The improved vehicle safety system according to claim 12, wherein said electrical circuit switch comprises a latching relay.

15. The improved vehicle safety system according to claim 14, wherein said latching relay comprises a single-pole double throw relay.

16. The improved vehicle safety system according to claim 14, wherein said electrical circuit switch comprises a first switch, second switch and third switch.

17. The improved vehicle safety system according to claim 16 wherein said first switch comprises a latching relay.

18. The improved vehicle safety system according to claim 17, wherein said latching relay comprises a single-pole double throw relay.

19. The improved vehicle safety system according to claim 17, wherein said second switch and said third switch both comprises a non-latching relay.

20. The improved vehicle safety system according to claim 19, wherein said second switch and said third switch both comprise a non-latching single-pole double throw relay.

21. The improved vehicle safety system according to claim 12, wherein said countdown timer comprises a manually settable countdown timer.

22. The improved vehicle safety system according to claim 12, wherein said manually settable countdown timer comprises a resistor bank with jumper connector.
